(19) United States
(12) Patent Application Publication
(10) Pub. No.: US 2023/0125633 A1
(43) Pub. Date: Apr. 27, 2023

(54) NANOPOROUS ELECTRODE

(71) Applicant: SAFT, LEVALLOIS PERRET (FR)

(72) Inventors: Vincent PELE, BORDEAUX (FR); Christian JORDY, ST LOUIS DE MONTFERRAND (FR)

(73) Assignee: SAFT, LEVALLOIS PERRET (FR)

(21) Appl. No.: 17/915,596

(22) PCT Filed: Mar. 30, 2021
(86) PCT No.: PCT/EP2021/058324

§ 371 Date: Sep. 29, 2022

(30) Foreign Application Priority Data
Mar. 31, 2020 (FR) FR2003195

(51) Int. Cl. H01M 4/04; H01M 4/62; H01M 4/40

(52) U.S. Cl. CPC H01M 4/0404; H01M 4/625; H01M 4/626; H01M 4/405; H01M 4/623; H01M 4/0421; H01M 2004/021

(57) ABSTRACT

The present application relates to an electrode comprising pillars of conductors covered with at least two layers for improving the deposition of lithium, and the electrochemical cells and batteries comprising same.

### CROSS REFERENCE TO RELATED APPLICATIONS

The present application is a U.S. National Phase Application under 35 U.S.C. § 371 of International Patent Application No. PCT/EP2021/058324 filed Mar. 30, 2021, which claims priority of French Patent Application No. 20 03195 filed Mar. 31, 2020. The entire contents of which are hereby incorporated by reference.

### FIELD OF THE INVENTION

The present invention relates to the field of energy storage, and more precisely to batteries, in particular lithium batteries.

### BACKGROUND

Lithium-ion rechargeable batteries provide excellent energy and volume densities and currently have a prominent place on the market of portable electronics, electric and hybrid vehicles or stationary energy storage systems.

Solid electrolytes also provide further significant improvement in terms of safety since same have a much lower risk of flammability than liquid electrolytes.

The operation of lithium batteries is based on the reversible exchange of the lithium ion between a positive electrode and a negative electrode which are separated by an electrolyte, the lithium being deposited at the negative electrode during operation while charging.

It is thus desirable to enhance the deposition of lithium and to obtain as homogeneous a deposit as possible.

Capacitor electrodes comprising aluminum current collectors on which carbon nanotubes (CNT) are deposited have been described by Arcila-Velez et al. (Nano Energy 2014, 8, 9-16).

KR101746927 describes an electrode comprising a protective layer containing a lithium salt, in order to prevent the corrosion of lithium by the liquid electrolyte. The protective layer may also include CNTs. Nevertheless, due to the very high nucleation energy thereof, lithium dendrites will form on the surface of the carbon. Hence such structure does not make a homogeneous deposition of lithium possible.

US 2019/088981 describes a cell for a battery, such that the negative electrode comprises conducting elements: there again, the deposition of lithium or lithium-containing alloy will greatly increase the thickness of the electrode, which leads to weakening of the structure during charging and discharging cycles.

US2017/133662 describes a lithium battery comprising a composite anode wherein lithium metal is inserted within the porous matrix. Nevertheless, lithium is herein present initially and this type of solution does not allow lithium to be maintained within the porosity of the carbon during cycling, which leads to a significant variation in the thickness of the negative electrode. It has actually been observed that after several cycles, lithium is no longer inserted into the porous carbon structure but between the porous carbon layer and the current collector (Y. G. Lee et al, NAT Energy (2020). https://doi.org/10.1038/s41560-020-0575-z). Such phenomenon is explained by the migration of the particles of the material forming alloys with lithium, towards the surface of the current collector under the layer of carbon particles. Such a solution does not allow lithium to be stored in the porosity of carbon and will thus generate significant variations in the thickness of the negative electrode causing a degradation of the service life and furthermore, it requires high mechanical pressures to be applied to the accumulator during operation.

Terranova et al. Journal of Power sources 246 (2014) 167-177 and WO 2017/034650 describe electrodes based on carbon nanotubes but do not in any way describe the inhibition of the variation in thickness of said electrodes during charging and discharging cycles.

It is thus desirable to provide a negative electrode whose structure and composition allow the quantity and quality of the lithium deposition to be increased while avoiding strong variations in thickness.

### SUMMARY

The invention thus aims in particular, to provide a nano-porous negative electrode comprising conductor pillars arranged on the current collector, said electrode being characterized in that the surface of said pillars is at least partially covered with a layer of a material consisting of at least one element forming alloys with lithium

According to one embodiment, the pillars are such that same consist of electronic conducting particles which are in direct contact with the current collector.

Typically, it means that for the vast majority of the particles of the invention (typically more than 90%), during an SEM observation, no space is seen between the current collector and one of the surfaces of the particles (corresponding to the base of the pillar); taking into account the resolution of the SEM, this space should be less than 1 nm.

Because there is no space between the collector and the base of the particles (here, the pillars), the compound forming alloys with lithium cannot migrate between the collector and the constituent material of the pillar, hence the formation of lithium metal in the porosity of the electrode will be maintained throughout cycling.

The electrode structure according to the invention thus provides a homogeneous deposition of lithium within the nano-porous structure while strongly limiting the volume variations of the electrode.

The term “nano-porous” according to the invention means a pore size of less than 300 nm.

The pore size corresponds to the structure of the material having an organized network of channels of very small variable pore size (typically less than 300 nanometers), which gives same, a particularly large active surface area per unit of electrode surface area.

The term “negative electrode”, refers, whenever the battery is in discharge, to the electrode acting as an anode and, whenever the battery is in charge, to the electrode acting as a cathode, the anode being defined as the electrode where an electrochemical oxidation reaction (electron emission) takes place, while the cathode is the seat of a reduction.

As used here, the term “conductor pillars” refers in particular to pillars as described by Wei et al. (Microelectronic Engineering, Vol. 158, 2016, 22-25). In particular, this term illustrates the arrangement of a plurality of elements consisting of a conducting material, such that said elements are generally parallel to one another, and such that same are arranged on a surface at an angle varying between about 70 and 90° with the surface, e.g. at a right angle. The pillars form the porous structure and support the alloy-forming compound.

Typically, said pillars are arranged in a comb shape, such that the spaces situated between said pillars, form channels with a length which can vary from 1 μm to 1 mm, typically from a few micrometers to several hundred micrometers. Said pillars can have sizes and spacings of a few nanometers to several hundred nanometers, preferentially of 10 to 100 nm.

According to one embodiment, the conductor pillars are chosen from copper pillars, carbon nanotubes or microporous carbons.

In one embodiment, the carbon nanotubes are vertically aligned carbon nanotubes (VACNT).

The expression “material forming alloys with lithium” or “lithiophilic” material defines a material with an affinity for lithium.

According to one embodiment, the electrode according to the invention, does not contain lithium metal before same is put into operation.

According to one embodiment, the lithiophilic element is chosen from silver, zinc and magnesium. Typically, the alloys formed by these elements with lithium include alloys such as LiₓZn_{y}, LiₓMg_{y}, and LiₓAg_{y}, with variable atomic ratios x/y.

According to one embodiment, a second nanometric lithium conducting layer is deposited on at least a portion of the surface of the first layer.

The “nanometric layer” mentioned here refers to the thickness of the second layer, which can vary from a few nanometers up to less than 100 nm, typically less than 50 nm.

Typically, the second layer comprises a polymer, a ceramic or a gel.

The second layer is lithium conducting, in that same allows the Li⁺ ions to transit from the electrolyte layer to the first layer. Further, the second layer can make the homogenization of the lithium deposition possible by allowing local cells to be formed: indeed, during charging, a potential difference is created in the thickness of the electrode; such potential difference can then provide an electrochemical rebalancing over the electrode thickness by an oxidation of lithium in the zones with the most positive potentials and a reduction of Li⁺ in the zones with the most negative potentials.

According to one embodiment, the porosity of the electrode is comprised between 45 and 98%, so as to allow the lithium metal to be received in the porosity and to maintain a mechanical strength of the electrode.

According to one embodiment, the negative electrode according to the invention, further comprises a third layer comprising an electrolyte.

According to one embodiment, the surface density of CNT is comprised between 109 and 2×10¹¹ CNT/cm².

According to one embodiment, the porosity of the electrode is such that:

E×ε>4.85×C [Maths 1]
where C is the surface capacity of the positive electrode (in mAh/cm²);
E is the thickness of the negative electrode in the discharged state, expressed in μm; and
ε is the porosity of the negative electrode in the discharged state (the porosity being defined as the ratio of the difference between the total volume of the electrode (excluding the current collector) and the volume of material divided by the volume of the electrode).

According to one embodiment, said electrode has a thickness in the charged state (EC) and a thickness in the discharged state (ED), such that:

Ec−Ed<4.85×C×h, [Maths 2]
where C is the surface capacity of the positive electrode (in mAh/cm²);
h is a dimensionless number comprised between 0 and 0.3.

As used here, the term “surface capacity (or C)” refers to the amount of electricity the electrode can deliver per unit area.

According to another subject matter, the present invention further relates to a process for preparing a negative electrode according to the invention, said process comprising the step of successively depositing the first layer and then the second layer, each of the deposition steps being performed by a physical or chemical process in vapor phase (PVD or CVD, respectively), or by a wet process.

As examples of physical or chemical vapor deposition (CVD or PVD), atomic layer deposition (ALD) can be cited in particular. Deposition by wet process can be cited, in particular electrolytic deposits.

According to another subject matter, the present invention further relates to an electrochemical element comprising a negative electrode according to the invention, characterized in that same relates to an all-solid-state or hybrid (containing at least one inorganic electrolyte and one organic polymer electrolyte) batteries, e.g. a Li free battery.

According to another subject matter, the present invention further relates to an electrochemical element comprising a negative electrode according to the invention, characterized in that same is a “lithium free” battery

The term “lithium free” defines herein the fact that the battery does not contain metallic lithium during the assembly of the battery, but that lithium is deposited in metallic form and then consumed in situ in a controlled and reversible manner during battery operation. Typically, lithium is deposited within the negative electrode during charging and consumed during discharging.

The term “electrochemical cell” refers to an elementary electrochemical cell consisting of the positive electrode/electrolyte/negative electrode assembly for storing the electrical energy supplied by a chemical reaction and for restoring same in the form of a current.

According to another subject matter, the present invention further relates to an electrochemical module comprising a stack of at least two elements according to the invention, each element being electrically connected with one or a plurality of other elements.

The term “module” refers herein to an assembly of a plurality of electrochemical elements, where said assemblies can be in series and/or in parallel.

A further subject matter of the invention is a battery comprising one or a plurality of modules according to the invention.

The term “battery” or accumulator refers to an assembly of a plurality of modules according to the invention.

According to one embodiment, the batteries according to the invention are accumulators with a capacity greater than 100 mAh, typically 1 to 100 Ah.

### BRIEF DESCRIPTION OF THE DRAWINGS

FIG. 1 is a schematic drawing of the electrode structure according to the invention.

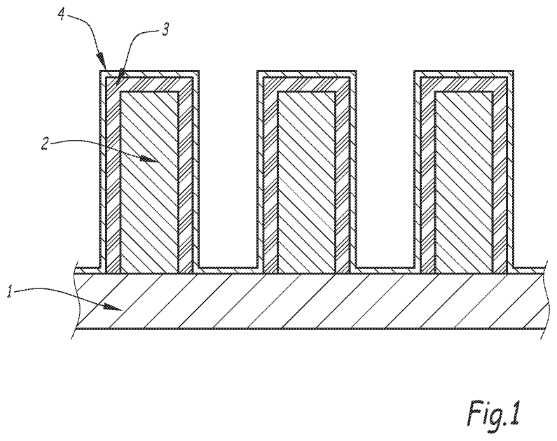

FIG. 2 is a schematic drawing of the structure of an electrode according to the aforementioned FIG. 1, in the charged state, where Li (5) is present around the pillars.

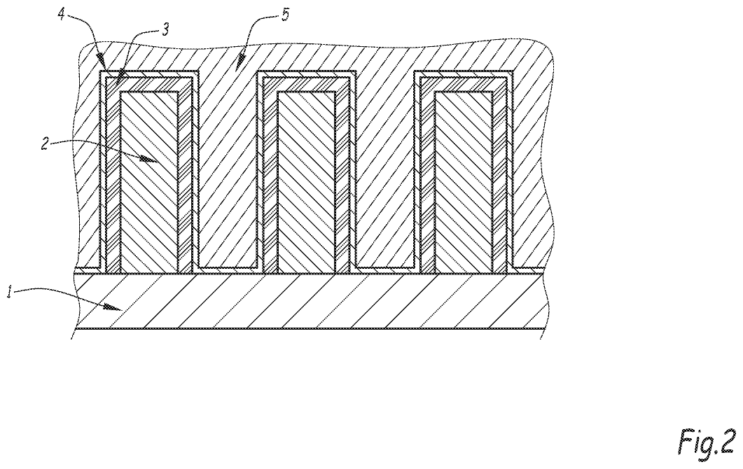

### DETAILED DESCRIPTION

The current collector (1), such as a metal strip, has a flat surface, on which pillars of conducting material (2) rise, such as copper pillars or carbon nanotubes.

The pillars (2) are covered with at least one layer:
first, in direct contact with the pillar, a first layer (3) made of a material apt to form alloys with lithium; and
on this first layer and in contact with the electrolyte: if appropriate, a second layer (4) conducting Li⁺ ions.

In operation, during charging, Li⁺ ions arriving from the solid electrolyte layer separating the 2 positive and negative electrodes, react at the ends of the pillar. When the pillar is made of carbon, the latter forms a lithiated compound of variable formula (e.g., in the case of graphite, the composition thereof is CLI_{0.17}), when the potential of the negative electrode reaches potentials less than 0V, a deposition of lithium should form; nevertheless, the formation of metallic lithium requires a nucleation energy which may be relatively high on the carbon and corresponds to an overvoltage. Supersaturation of the carbon with lithium can thus take place and lithium will thus diffuse into the pillar; adding a material forming alloys with lithium to the surface of the CNT will reduce the metallic lithium formation overvoltage. Lithium in the structure of the supersaturated lithiated carbon will thus be able to be converted into metallic lithium on the layer deposited on the surface of the CNT. It should be incidentally noted that the alloy-forming material will already have been lithiated before the precipitation of metallic lithium because the formation potential thereof is greater than that of metallic lithium. In parallel with this process, the lithium ions can also flow through said possible second layer so as to be deposited under this layer, in the form of metallic Li.

The following examples are given as a non-limiting example of an embodiment of the present invention.

### EXAMPLES

Producing Electrochemical Cells:

Relating to the preparation of the negative electrode, the deposition of VACNT can be performed as described in the article by Arcila-Velez et al., Nano Energy, Volume 8, 2014, 9-16: VACNT tubes are made of a quartz tube with a diameter of 5 cm; the 2 ends of the tube are partially closed with stainless steel. The tube is placed in an oven with 2 hot zones, the first zone serving for preheating, while the reaction takes place in the second zone. A pump is used to inject the precursor (solution of ferrocene in xylene, containing e.g. 0.5 at % of iron) in the center of the preheating zone. Copper sheets cleaned with acetone, a few cm wide and long, are placed in the oven, in the center of the reaction zone. The system is brought to 600° C. under a stream of argon and hydrogen (17% by volume of H₂). The precursor is injected at 600° C. with a low flow rate, e.g. from 0.1 to 1.5 ml/h, into a stream of C₂H₂ with a flow rate of 30 cm³/min. The treatment time varies from 5 to 50 min depending on the desired length of the CNT.

The depositions of the first and second layers can be made according to the following methods:

TABLE 1

| Methods | First layer | Second layer |
|---|---|---|
| 1 | PECVD in 2 steps: | ALD |
| | ALD deposition for depositing | |
| | a layer of AgO or ZnO; and | |
| | a reduction heat treatment | |
| | under hydrogenated argon | |
| | (between e.g. 300 and 500° C.) | |
| 2 | PECVD | ALD |
| 3 | PECVD in 2 steps: | MLD |
| | ALD deposition for depositing | |
| | a layer of AgO or ZnO; and | |
| | followed by a reduction heat | |
| | treatment under hydrogenated | |
| | argon (between e.g. 300 and | |
| | 500° C.) | |
| 4 | PECVD | ALD |
| 5 | ALD | ALD |
| 6 | ALD | immersion in a solution |
| | | containing the gel |
| | | constituents dissolved in |
| | | a solvent or a solvent |
| | | mixture containing, e.g., |
| | | acetonitrile and/or |
| | | acetone. |

The preparation of the electrolyte layer and the positive electrode is carried out under an argon atmosphere (<1 ppm H₂O).

The electrolytic membrane is obtained in a plurality of steps. A first step of mixing a sulfide electrolyte such as argyrodite Li₆PS₅Cl with 2% by mass of a copolymer binder containing polyvinylidene fluoride is carried out in a planetary mill. The mixing is carried out at a rate of 1000 rpm for 10 min with a plurality of solvents: xylene and isobutyl isobutyrate which are priorly dried using molecular sieves (pore size of 3 Å). In a second step, the ink thus obtained is coated on a PET film allowing the membrane to be detached after drying. The thickness of the membrane is 50 μm.

Similarly, the positive electrode is made from a material such as NMC with the composition LiNi0.60Mn0.20Co0.20O₂ covered with a 10 nm layer of LiNbO₃, mixed with solid electrolyte Li₆PS₅Cl, carbon fibers (VGCF) and a copolymer binder containing polyvinylidene fluoride, in the NMC mass proportions:Li₆PS₅Cl:VGCF:binder 70:30:3:3. These materials are dispersed in a mixture of xylene and isobutyl isobutyrate solvents. A homogeneous ink is obtained after passing through the planetary mixer. The ink is then coated on an aluminum current collector covered beforehand with a thin layer of carbon. The grammage of the electrode is varied between 15 and 95 mg/cm².

After drying, a 12 mm diameter disk is cut from the electrolyte membrane along with a 10 mm diameter positive electrode disk. The two discs are compressed against each other in a mold under a pressure of 5.6 t.

For a given example, a 10 mm diameter disk is cut out from the negative electrode corresponding to the example and placed on the other side of the electrolytic membrane. This stack is then compressed at a pressure of 1 t/cm² and can undergo a heat treatment between 80 and 130° C. for 12 h.

The stack is then placed in a Swagelok cell compressed at a pressure comprised between 1 and 5 MPa. For electrical tests, charging and discharging are performed at a speed of C/20.

### Counter Examples

For the comparative example No. 1, the CNT powder with a diameter of 40 nm and a length comprised between 20 and 50 μm is dispersed in an organic solvent (e.g. NMP) in the presence of 2% PVDF. The mixture is deposited on a copper collector, then dried at 120° C. and compressed; the thickness of the layer is 25 μm. A deposition of silver is then carried by PECVD on the layer thus produced, followed by an LiPON deposition by ALD. The negative electrode is then produced by cutting a 10 mm diameter coated collector disc.

For the comparative examples 2 to 5, the method of preparation of the negative electrodes is similar to that used for examples 1 to 6.

The electrochemical cells are then prepared in an identical manner to examples 1 to 6.

The examples described in Tables 2 and 3 show that the thickness variations are significantly less than in the comparative examples 1 and 4 described in Tables 4 and 5; indeed, the negative electrodes of the comparative examples 4 and 5 correspond to an increase in thickness corresponding to more than 60% of the initial thickness.

The comparative examples 2, 3 and 5 have too large inter-CNT distances which give rise to problems of mechanical strength in the CNTs under pressure, associated with a heterogeneous lithium deposition resulting in a shorter service life.

TABLE 2

| | | | | Average | | | | |
|---|---|---|---|---|---|---|---|---|
| | | CNT | CNT | distance | | Thickness | | |
| | capacity | Diameter | Length | between | Composition | 1^{st} layer | Composition | Thickness |
| Example | (mAh/cm²) | (nm) | (μm) | CNT (nm) | 1^{st} layer | (nm) | 2^{nd} layer | 2^{nd} layer |
| 1 | 4 | 40 | 25 | 236 | Ag | 10 | LiPON | 10 |
| 2 | 4 | 10 | 30 | 82 | Si | 2 | Li₂ZrO₃ | 2 |
| 3 | 6 | 20 | 50 | 30 | Zn | 5 | PEO/LiTFSI | 20 |
| 4 | 6 | 50 | 40 | 30 | Mg | 5 | LLZO | 5 |
| 5 | 6 | 10 | 60 | 4 | Al2O3 | 2 | | |
| 6 | 10 | 100 | 60 | 188 | SiO2 | 4 | PC-PVDF | 10 |
| | | | | | | | LiTFSI gel | |

The following particularities are observed for the embodiments of Table 2 above:
Example 1: Inter-CNT distance on the order of 300 nm;
Example 2: small thickness of the surface layers;
Example 3: large surface capacity;
Example 4: Ec−Ed>0 but <0.2×4.85° C.;
Example 5: small pore size=small inter-CNT distance;
Example 6: very large surface capacity.

TABLE 3

| | Thickness | Thickness | CNT | | | | | |
|---|---|---|---|---|---|---|---|---|
| | in discharged | in charged | density | porosity | | 4.85*C | Ec − Ed | |
| Example | state (*) | state (*) | per cm² | % | Ed(μm)*poro | (mAh/cm²) | (μm) | 4.85*0.2*C |
| 1 | 25 | 25.0 | 1.00E+09 | 95 | 23.74 | 19.40 | 0.00 | 3.88 |
| 2 | 30 | 30.0 | 1.00E+10 | 97 | 29.24 | 19.40 | 0.00 | 3.88 |
| 3 | 50 | 50.0 | 1.00E+10 | 62 | 30.76 | 29.10 | 0.00 | 5.82 |
| 4 | 40 | 44.5 | 1.00E+10 | 62 | 24.61 | 29.10 | 4:49 AM | 5.82 |
| 5 | 60 | 60.0 | 2.00E+11 | 49 | 29.46 | 29.10 | 0.00 | 5.82 |
| 6 | 60 | 60.0 | 1.00E+09 | 87 | 52.28 | 48.50 | 0.00 | 9.70 |

(*) negative electrode thickness without collector thickness for one electrode side

### Comparative Examples

The following examples were obtained from cells comprising negative electrodes, the characteristics of which are given in Tables 4 and 5.

TABLE 4

| | | | | Average | | | | |
|---|---|---|---|---|---|---|---|---|
| | | CNT | CNT | distance | | Thickness | | |
| comparative | capacity | Diameter | Length | between | Composition | 1^{st} layer | Composition | Thickness |
| example | (mAh/cm²) | (nm) | (μm) | CNT (nm) | 1^{st} layer | (nm) | 2^{nd} layer | 2^{nd} layer |
| 1 | 4 | 40 | 25 | 236 | AG | 10 | LIPON | 10 |
| 2 | 4 | 40 | 25 | 276 | — | 0 | — | 0 |
| 3 | 4 | 40 | 25 | 960 | AG | 10 | LIPON | 10 |
| 4 | 6 | 40 | 30 | 5 | AG | 5 | LIPON | 5 |
| 5 | 6 | 2000 | 50 | 1162 | AG | 5 | LIPON | 5 |

The following particularities are observed for the embodiments of Table 4 above:
Example 1: CNT powder deposited on a Cu collector=>all Li is deposited between CNT and copper;
Example 2: Poor penetration of lithium into the porosity=>poor service life and swelling of the electrode;
Example 3: Inter-CNT distance>300 nm=>low mechanical strength;
Example 4: E*poro>4.85.C and Ec−Ed>0.2×4.85×C: strong electrode swelling corresponding to more than 60% of the electrode thickness=>poor service life;
Example 5: Poor penetration of lithium into the porosity and small developed surface of carbon leading to dendrite formation.

TABLE 5

| | Thickness | Thickness | CNT | | | | | |
|---|---|---|---|---|---|---|---|---|
| comparative | in discharged | in charged | density | porosity | | 4.85*C | Ec − Ed | |
| example | state (*) | state (*) | per cm² | % | Ed(μm)*poro | (mAh/cm²) | (μm) | 4.85*0.2*C |
| 1 | 25 | 45 | | 95 | 23.74 | 19.40 | 20 | 3.88 |
| 2 | 25 | 40.0 | 1.00E+09 | 99 | 24.69 | 19.40 | 0.00 | 3.88 |
| 3 | 25 | 25.0 | 1.00E+08 | 100 | 24.97 | 19.40 | 0.00 | 3.88 |
| 4 | 30 | 47.9 | 5.00E+10 | 37 | 11:15 AM | 29.10 | 17.95 | 5.82 |
| 5 | 50 | 50.0 | 1.00E+07 | 69 | 34.29 | 29.10 | 0.00 | 5.82 |

It thus appears in particular that when E*poro>4.85.C (example 4), a strong swelling of the electrode is observed.

1. A nanoporous negative electrode comprising conducting pillars disposed on the current collector, such that the porosity of said negative electrode is such that:
E×ε>4.85×C
where C is the surface capacity of said positive electrode (in mAh/cm²);
E is the thickness of said negative electrode in the discharged state, expressed in μm; and
ε is the porosity of said negative electrode in the discharged state (the porosity being defined as the ratio of the difference between the total volume of the electrode (excluding the current collector) and the volume of said material divided by the volume of the electrode),
said electrode being characterized in that the surface of said pillars is at least partially covered with a layer of a material consisting of at least one element forming alloys with lithium.

2. The negative electrode according to claim 1 comprising a second nanometric conducting layer for the lithium deposited on at least a portion of the surface of said layer.

3. The negative electrode according to claim 1 wherein the conducting pillars are selected from copper pillars, carbon nanotubes or microporous carbons.

4. The negative electrode according to claim 3 wherein the carbon nanotubes are vertically aligned carbon nanotubes (VACNT).

5. The negative electrode according to claim 2 wherein the second layer comprises a polymer, a ceramic or a gel.

6. The negative electrode according to claim 2, wherein the thickness of the second layer has a thickness comprised between 0 and 100 nm.

7. The negative electrode according to claim 1, wherein the lithiophilic element is selected from silver, zinc and magnesium.

8. The negative electrode according to claim 2 as same further comprises a third layer comprising an electrolyte.

9. The electrode according to claim 1 having a thickness in the charged state (Ec) and a thickness in the discharged state (Ed), such that:
Ec−Ed<4.85×C×h,
where C is the surface capacity of the positive electrode (in mAh/cm²);
h is a dimensionless number comprised between 0 and 0.3.

10. A method for preparing an electrode according to claim 1 comprising the step of successively depositing a first layer and, where appropriate, a second layer, each of the depositing steps being carried out by a physical or chemical process in the vapor phase (PVD or CVD, respectively), or by a wet process.

11. An electrochemical cell comprising a negative electrode according to claim 1, characterized in that same relates to an all-solid-state or hybrid battery.

12. The electrochemical cell according to claim 11, such that same relates to an Li free battery, in that same does not contain metallic lithium during assembly.

13. An electrochemical module comprising the stack of at least two elements according to claim 11, each element being electrically connected to one or a plurality of other elements.

14. A battery comprising one or more modules according to claim 13.
